(19) United States
(12) Patent Application Publication
(10) Pub. No.: US 2009/0290966 A1
(43) Pub. Date: Nov. 26, 2009

(54) Thumb Accessory for Extendable Dipper Stick

(76) Inventor: George King, Knightstown, IN (US)

Correspondence Address: OVERHAUSER & LINDMAN, 740 W. GREEN MEADOWS DRIVE, SUITE 300, GREENFIELD, IN, 46140, US

(21) Appl. No.: 12/469,224

(22) Filed: May 20, 2009

Related U.S. Application Data
(60) Provisional application No. 61/054,536, filed on May 20, 2008.

(51) Int. Cl. B66C 1/48

(52) U.S. Cl. 414/739

(57) ABSTRACT

An illustrative gripping accessory or thumb is adapted for use with a machine having a tool, for example, a backhoe bucket attached to an extendable or non-extendable arm of a dipper stick. The accessory or thumb can be releasably attached to the machine and includes a pair of grip members that can be pivotably coupled to the distal pivot pin connecting the bucket and extendable arm and a grip linkage coupled between each grip member and the intermediate pivot coupling the extendable arm and the rotatable linkage coupled to the bucket rotation cylinder. Thus the use of the gripping accessory with a bucket requires no welding or other permanent modification of the machine and can be stowed or removed when not in use.

### CROSS-REFERENCE TO RELATED APPLICATION

This application claims the benefit of U.S. Provisional Patent Application No. 61/054,536, filed May 20, 2008, and titled THUMB ACCESSORY FOR EXTENDABLE DIPPER STICK, which is incorporated herein by reference.

### BACKGROUND

The invention relates to tool accessories for earthwork and construction machines, and more specifically, to combined tools for operations such as scooping and gripping.

Machines such as a tractor loader backhoe, excavator, or trencher often include an articulating boom and a dipper stick connecting a moveable and rotatable tool such as a bucket or scoop to the boom. Such machines and tools are generally used for various earthwork and construction, for example, scooping operations such as digging and moving material such as dirt, gravel, or the like, and for breaking material such as concrete slabs. Other machines include an articulating boom and dipper stick having a tool for gripping and moving materials, for example, a tool having opposing and pivotable claw-like members, sometimes referred to as a grapple. A bucket type tool is generally not suitable for gripping operations and the claw tool is generally not suitable for scooping operations.

One solution has been to provide an aftermarket “thumb” accessory for mounting on the distal end of the dipper stick, adjacent the bucket. Such thumbs are typically designed to be welded to the dipper stick and therefore are not removable. Additionally, the welding may damage and generally voids the warranty on the dipper stick and boom. This solution is also not feasible for use on machines having a tool coupled to an extendable arm that telescopes from within a dipper stick sleeve. If welded to the dipper stick sleeve, the thumb is only usable when the extendable arm is in the retracted position. If welded to the extendable arm, then the thumb will prevent the extendable arm from movement to its retracted position.

### SUMMARY

The present invention may comprise one or more of the following features and combinations thereof.

An illustrative system according to the present disclosure includes a gripping accessory for a machine having a tool, for example, a bucket attached to an extendable or non-extendable arm of a dipper stick. The accessory includes a pair of grip members pivotably coupled to the distal pivot pin connecting the bucket and arm. The accessory also includes a grip linkage coupled between each grip member and the intermediate pivot coupling the extendable arm and the rotatable linkage coupled to the bucket rotation cylinder. The accessory optionally includes a support member coupled between the two grip linkages. Advantageously the accessory is removably coupled using the existing pivot joints so that no modification of the machine is required.

Additional features of the disclosure will become apparent to those skilled in the art upon consideration of the following detailed description of the illustrative embodiment.

### BRIEF DESCRIPTION OF THE DRAWINGS

The detailed description particularly refers to the accompanying figures in which:

FIG. 1 is a side view illustrating a first illustrative embodiment of a grip accessory releasably coupled with an extendable arm of a machine having a bucket, dipper stick, and boom;

FIG. 2 is side view illustrating a machine prior to releasable attachment of the grip accessory of FIG. 1;

FIG. 3 is a side view illustrating prior art thumb welded to the distal end of a dipper stick;

FIG. 4 is a side perspective view illustrating the grip accessory of FIG. 1;

FIG. 5 is a side perspective view illustrating the grip accessory of FIG. 1 with a middle coupling location used for the grip accessory;

FIG. 6 is a side perspective view illustrating the grip accessory of FIG. 1 in use with the machine bucket rotated to grip and move material;

FIG. 7 is a side perspective view illustrating the gripping operation of FIG. 6 with the extendable arm advanced to the extended position from the dipper stick housing;

FIG. 8 is a side perspective view illustrating the grip accessory of FIG. 1 with a near coupling location used for the grip accessory;

FIG. 9 is a side perspective view illustrating the grip accessory of FIG. 1 with a distal coupling location used for the grip accessory, thus stowing the grip accessory while not in use.

### DESCRIPTION OF THE ILLUSTRATIVE EMBODIMENTS

For the purposes of promoting and understanding the principals of the invention, reference will now be made to one or more illustrative embodiments illustrated in the drawings and specific language will be used to describe the same.

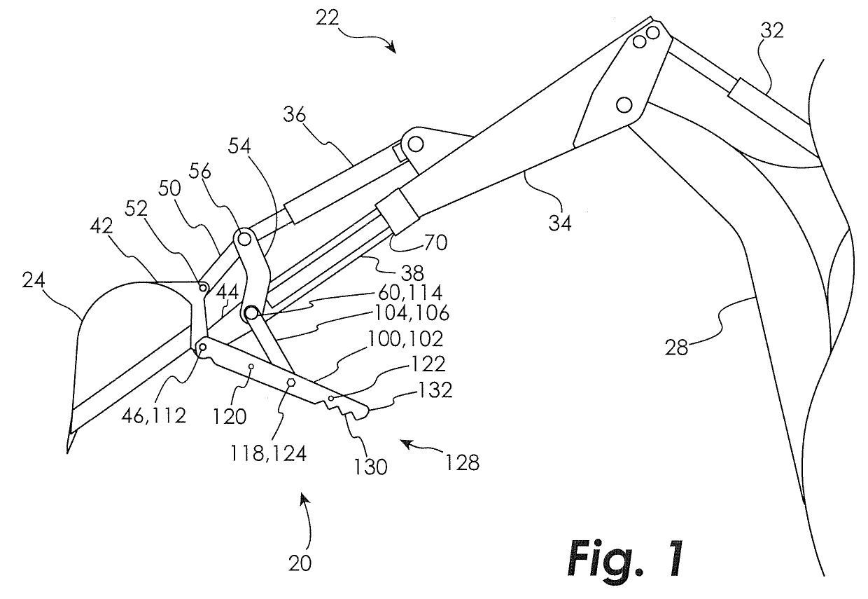

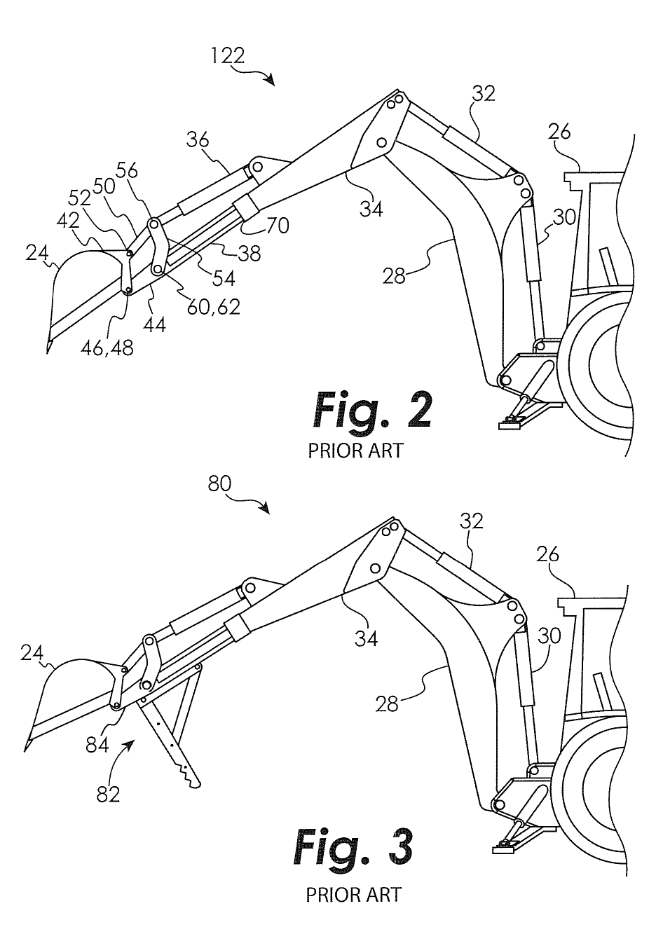

Referring to FIG. 1, an illustrative embodiment of machine 22 includes the releasably coupled grip accessory 20. The exemplary machine 22 is of the tractor loader backhoe type, however, the accessory 20 may be used with other types of machines, for example, those with a bucket 24 or scoop, for example, excavators or trench digging machines. To understand the interoperability of the other components of the machine 22 and the grip accessory 20, prior art machine 122, shown in FIG. 2 and of the same type as the machine 22 before installation of the accessory 20, will be described.

The prior art machine 122 includes a vehicle or carriage 26, boom 28, boom cylinder 30, dipper cylinder 32, dipper stick 34, tool cylinder 36, and extendable arm 38. The bucket 24 includes a flange 42 for coupling the bucket to the extendable arm 38. The flange 42 is coupled to the distal end 44 of the extendable arm 38 at pivot joint 46 using pivot pin 48. The bucket 24 is further coupled to the extendable arm 38 via a thrust linkage 50. The thrust linkage 50 is coupled to the flange 42 at pivot joint 52 and to a follower linkage 54 at a pivot joint 56. The follower linkage 54 is further coupled to the extendable arm 38 at a pivot joint 60 using a pivot pin 62.

The flange 42, thrust linkage 52, follower linkage 54, and distal end 44 of the extendable arm 38 form a four-bar linkage operated by the tool cylinder 36 to rotate the bucket 24. The extendable arm 38 is operable to extend and retract within housing 70 of the dipper stick 34. The dipper stick 34 is operable to rotate relative to the boom 28 using dipper cylinder 32 and the boom 28 is operable to rotate relative to the carriage 26 using boom cylinder 30. The prior art machine 122 shown in FIG. 2 lacks a structure to grip materials or to grapple or otherwise stabilize the bucket 24 relative to a material.

Referring to FIG. 3, another exemplary prior art machine 80 has been modified by welding or other non-removably coupling of a prior art thumb accessory 82 to the distal end 84 of the dipper stick 34, either an extendable portion (as shown) or a non-extendable portion (not shown). Welding and other non-removably coupling are understood to include permanently altering operations, and as such, also require heat or contact cutting in order to again separate the components. In contrast, removably coupling according to this disclosure is understood to require only the release of mechanical fasteners to uncouple the components from the machine 80.

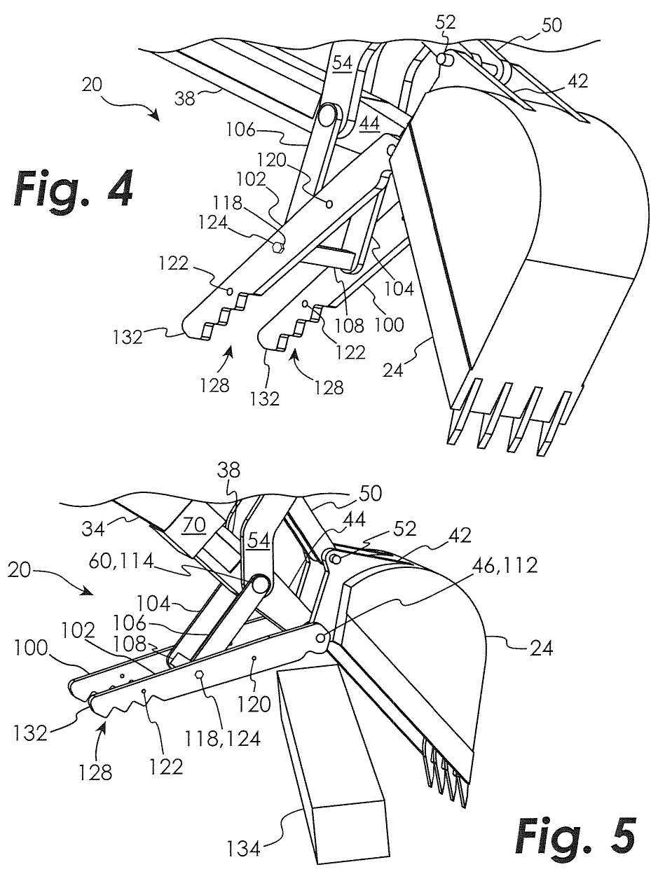

Referring again to FIG. 1, the illustrative embodiment of machine 22 is shown with releasably coupled grip accessory 20. The grip accessory 20 includes a pair of grip members 100 and 102, a pair of grip linkages 104 and 106, and optional stabilizer member 108 (FIG. 4).

Advantageously, the grip accessory 20 is releasably coupled to the extendable arm 38 using preexisting pivot joints 46 and 60. For example, pivot pins 48 and 62 shown in FIG. 2 are removed and pivot pins 112 and 114 installed at joints 46 and 60. The pins 112 and 114 can be the same diameter, material, and finishing characteristics as respective pins 48 and 62, but be longer in length to accommodate mounting of the grip accessory 20, namely, the added thickness of the pair of grip member 100 and 102 for the pin 112 and of the pair of grip linkages 104 and 106 for the pin 114. For example, about 4 inches in additional length. Such pins 48, 62, 112, and 114 are typically held into place by mechanical locking devices, for example cotter keys, on opposite ends.

The grip members 100 and 102 are coupled to the respective one of grip linkage 104 and 106 atone of a plurality of coupling locations 118, 120, and 122. For example, in FIG. 1, the linkages 104 and 106 are coupled to location 118 on the respective one of members 100 and 102, for example, using fasteners 124, which may also serve to couple stabilizer 108 (FIG. 4) between linkages 104 and 106. Additionally or alternatively, stabilizer 108 and/or additional stabilizers (not shown) may be coupled between the grip members 100 and 102, or may integrally couple members 100 and 102 and/or linkages 104 and 106.

The grip members 100 and 102 may also include friction or cutting devices, for example, teeth 128. The teeth 128 or distal ends 132 of the grip members 100 and 102 may also include replaceable inserts 130, for example, formed from harder or hardened metal than that used for the grip members 100 and 102. The material used for forming the grip members 100 and 102 and grip linkages 104 and 106 may be of the type typically used for forming bucket 24, for example, 1¼ inch or 2 inch steel.

Optionally, the grip members 100 and 102 may be curved along at least one longitudinal edge, for example, to accommodate gripping various materials, for example, railroad tie 134 shown in FIG. 5.

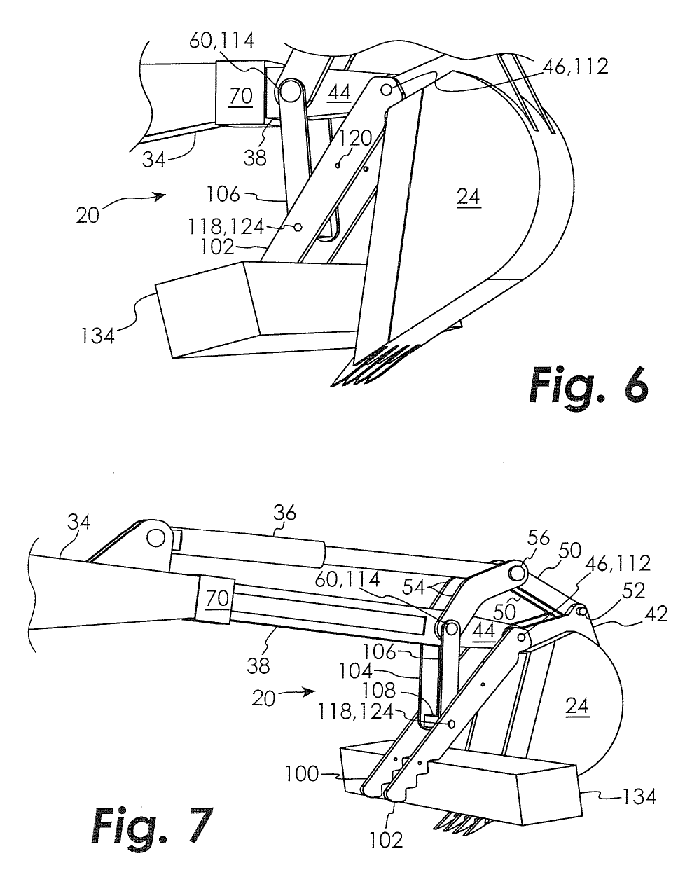

As configured in FIG. 5, the linkages 104 and 106 are coupled to the coupling locations 118 which may be located, for example, to allow contact of the bucket 24 with the grip members 100 and 102 at about mid-range of rotation of the bucket 24. For example, so that the angle between the arm 38 and the grip members is at least about 90 degrees. Advantageously, as shown in FIG. 6, rotation of the bucket 24 toward the grip accessory 20 provides for gripping and movement of materials such as tie 134. Additionally, because the grip accessory is only coupled with the extendable arm 38 and not the dipper stick 34, extendable arm 38 and be advanced to its extended position as shown in FIG. 7 while the bucket 24 and grip accessory 20 are in gripping use.

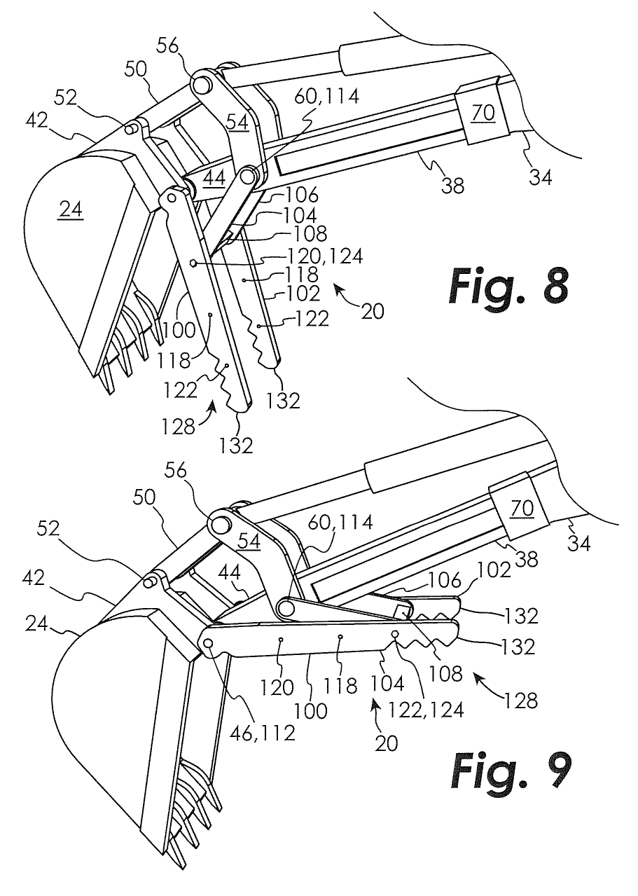

Referring to FIG. 8, coupling location 120 provides for contact between the bucket 24 and the grip members 100 and 102 in a smaller range of rotation, for example, about ¼ through the range of rotation of the bucket 24 toward the extendable arm 38. Referring to FIG. 9, the coupling location 122 provides positioning of the grip members 100 and 102 rotationally close to the extendable arm 38, for example, so that the angle between the arm 38 and the grip members is less than about 45 degrees, or less than about 30 degrees. The coupling location 122 may be used when the grip accessory 20 is not required for the operation the bucket 24 is being used for, and thus comprise a storage position, or to accommodate gripping large diameter materials (not shown), or to use the grip members 100 and 102 as a foot against the group for stabilizing (grappling) the arm 38, and dipper stick 34 while the bucket 24 is in operation.

The illustrative grip accessory 20 may also be releasably coupled as with machine 122 with a machine not having an extendable arm 38, for example, the prior art machine 80 shown in FIG. 3.

While the invention has been illustrated and described in detail in the foregoing drawings and description, the same is to be considered as illustrative and not restrictive in character, it being understood that only illustrative embodiments thereof have been show and described and that all changes and modifications that are within the scope of the claimed subject matter is desired to be protected.

1. An accessory for a machine, the machine having a tool coupled to an arm at a distal pivot and having a tool rotation linkage coupled to the arm at an intermediate pivot, the accessory comprising:
at least one grip member adapted to be coupled to the machine at the distal pivot; and
at least one linkage adapted to be coupled to the at least one grip member and the intermediate pivot.

2. The accessory of claim 1, further comprising:
a first pin adapted for releasably coupling the at least one grip member to the machine at the distal pivot; and
a second pin adapted for releasably coupling the at least one linkage to the arm at the intermediate pivot.

3. The accessory of claim 1, wherein the at least one grip member defines a plurality of positions for selectively coupling the at least one linkage along the length of the at least one grip member.

4. The accessory of claim 3, wherein coupling the at least one linkage to a first of the plurality of positions for coupling defines an angle between the at least one grip members and the arm of less than about 45 degrees.

5. The accessory of claim 3, wherein coupling the at least one linkage to a second of the plurality of positions for coupling defines an angle between the at least one grip members and the arm of at least about 90 degrees.

6. The accessory of claim 1, further comprising a support member, and wherein the at least one grip member includes a first and second grip member spaced laterally apart and having the support member coupled therebetween.

7. The accessory of claim 6, wherein the at least on linkage includes a first and second linkage positioned on respective sides of the arm, the first linkage coupled to the first grip member and the second linkage coupled to the second grip member.

8. A machine comprising:
a boom;
an arm rotatably coupled to the boom;
a tool rotatably coupled to a first pivot proximate a distal end of the arm;
a first tool rotation linkage coupled to the arm at an second pivot located proximal of the first pivot;
a second tool rotation linkage coupled to the tool and the first tool rotation linkage such that the arm between the first and second pivots, a portion of the tool, and the first and second tool rotation linkages comprise a four-bar linkage;
a first grip member adapted to be releasably coupled to the first pivot; and
a first grip linkage coupled to the first grip member and adapted to be releasably coupled to the second pivot.

9. The machine of claim 8, further comprising:
a second grip member adapted to be releasably coupled to the first pivot; and
a second grip linkage coupled to the second grip member and adapted to be releasably coupled to the second pivot.

10. The machine of claim 9, further comprising:
a first pin adapted for releasably coupling the first and second grip members at the first pivot; and
a second pin adapted for releasably coupling the first and second grip linkage at the second pivot.

11. The machine of claim 8, wherein the first grip member defines a plurality of positions for selectively coupling the first grip linkage along the length first grip member.

12. The machine of claim 1, wherein coupling the first grip linkage to a first of the plurality of positions for coupling defines an angle between the first grip members and the arm of less than about 45 degrees.

13. The machine of claim 11, wherein coupling the first grip linkage to a second of the plurality of positions for coupling defines an angle between the first grip members and the arm of at least about 90 degrees.

14. The machine of claim 9, further comprising a support member coupled between the first and second grip members.

15. The machine of claim 8, where the arm is extendable and the first grip member and first grip linkage are coupled to the machine such that position or orientation of the first grip member relative to the tool remains fixed during extension of the arm.

16. The machine of claim 8, where the tool is rotatably and the first grip member and first grip linkage are coupled to the machine such that position or orientation of the grip member relative to the arm remains fixed during rotation of the tool.

17. An accessory for a machine, the machine having a tool coupled to an arm at a distal pivot and having a tool rotation linkage coupled to the arm at an intermediate pivot, the accessory comprising:
first and second grip members releasably and rotatably coupled with a first pin to the distal pivot;
first and second grip linkages releasably and rotatably coupled with a second pin to the intermediate pivot; and
a support member coupled between at least one of the first and second grip members and the first and second grip linkages.

18. The accessory of claim 17, wherein the first and second grip members define a plurality of positions for selectively coupling the corresponding first and second grip linkage along the length of the first and second grip members.

19. The accessory of claim 18, wherein coupling the first and second grip linkages to a first of the plurality of positions for coupling defines an angle between the first and second grip members and the arm of less than about 45 degrees.

20. The accessory of claim 18, wherein coupling the first and second grip linkages to a second of the plurality of positions for coupling defines an angle between the first and second grip members and the arm of at least about 90 degrees.
